(19) United States
(12) Patent Application Publication
(10) Pub. No.: US 2015/0321535 A1
(43) Pub. Date: Nov. 12, 2015

(54) Air Conditioner Control Assembly

(71) Applicant: Edward Wehrenberg, Greeley, CO (US)

(72) Inventor: Edward Wehrenberg, Greeley, CO (US)

(21) Appl. No.: 14/273,091

(22) Filed: May 8, 2014

(51) Int. Cl. B60H 1/00

(52) U.S. Cl. CPC B60H 1/00735

(57) ABSTRACT

A air conditioner control assembly for disabling the air conditioner in a vehicle while the vehicle is traveling up an incline includes a housing coupled to the vehicle. A processor is coupled to the housing. The processor is operationally coupled to the air conditioner in the vehicle. The processor de-actuates the air conditioner. A inclinometer is coupled to the housing. The inclinometer is operationally coupled to the processor. The processor de-actuates the air conditioner when the inclinometer detects the vehicle is traveling up the incline. A timer is coupled to the housing. The timer is operationally coupled to the processor. The processor actuates the air conditioner after a trigger duration of time has passed while the vehicle is traveling up the incline.

### BACKGROUND OF THE DISCLOSURE

### Field of the Disclosure

The disclosure relates to control devices and more particularly pertains to a new control device for disabling the air conditioner in a vehicle while the vehicle is traveling up an incline.

### SUMMARY OF THE DISCLOSURE

An embodiment of the disclosure meets the needs presented above by generally comprising a housing coupled to the vehicle. A processor is coupled to the housing. The processor is operationally coupled to the air conditioner in the vehicle. The processor de-actuates the air conditioner. An inclinometer is coupled to the housing. The inclinometer is operationally coupled to the processor. The processor de-actuates the air conditioner when the inclinometer detects the vehicle is traveling up the incline. A timer is coupled to the housing. The timer is operationally coupled to the processor. The processor actuates the air conditioner after a trigger duration of time has passed while the vehicle is traveling up the incline.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a air conditioner control assembly according to an embodiment of the disclosure.

FIG. 2 is a top view of an embodiment of the disclosure.

FIG. 3 is a back view of an embodiment of the disclosure.

FIG. 4 is a schematic view of an embodiment of the disclosure.

FIG. 5 is an in-use view of an actuated condition of an embodiment of the disclosure.

FIG. 6 is an in-use view a de-actuated condition of an embodiment of the disclosure.

### DESCRIPTION OF THE PREFERRED EMBODIMENT

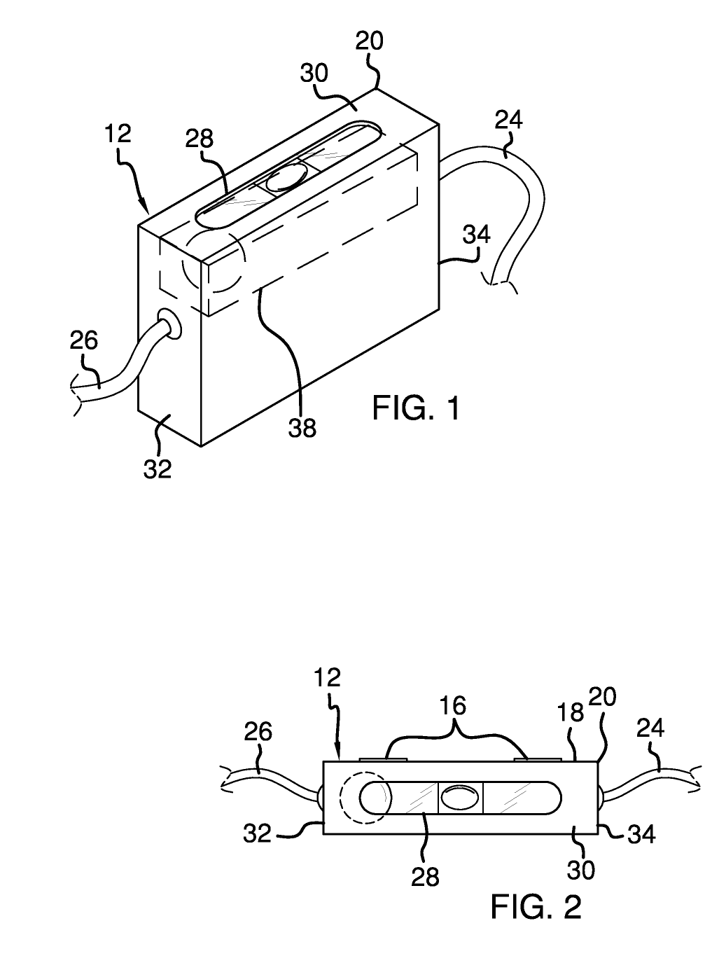

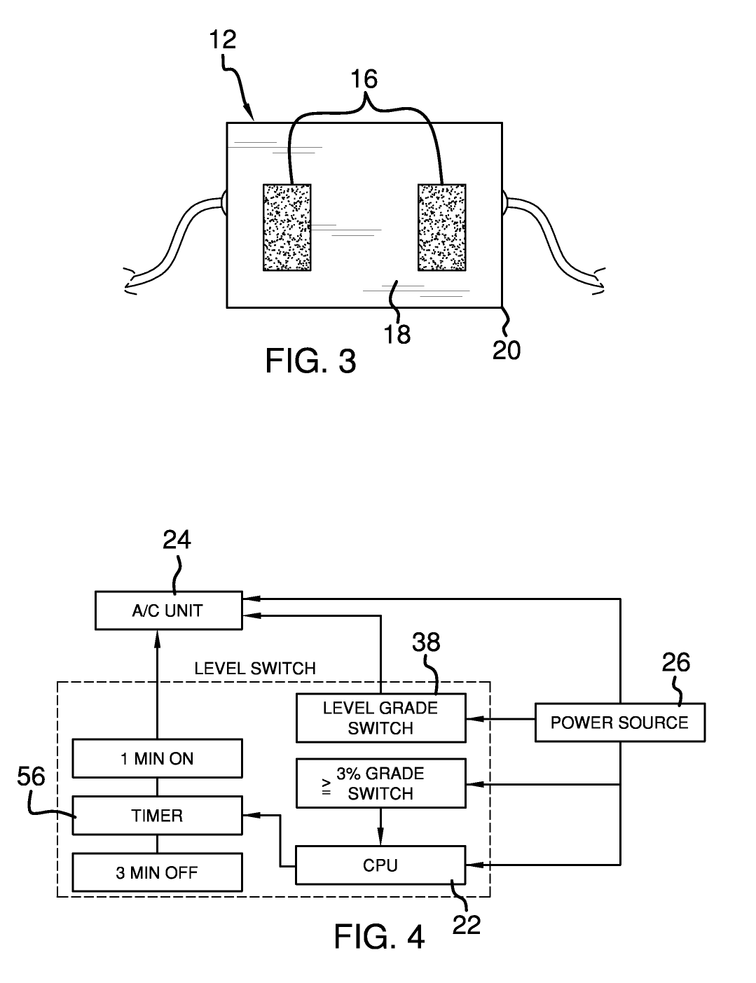

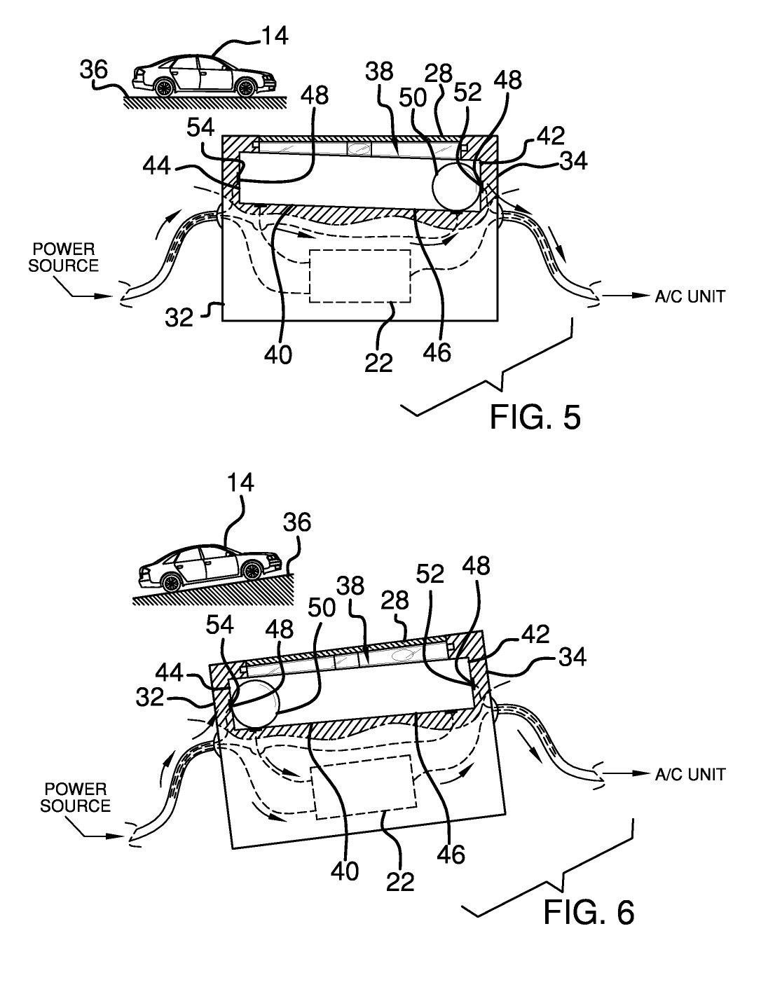

With reference now to the drawings, and in particular to FIGS. 1 through 6 thereof, a new control device embodying the principles and concepts of an embodiment of the disclosure and generally designated by the reference numeral 10 will be described.

As best illustrated in FIGS. 1 through 6, the air conditioner control assembly 10 generally comprises a housing 12 coupled to a vehicle 14. The vehicle 14 may be a passenger vehicle of any conventional design. A pair of couplers 16 is coupled to a back side 18 of an outer wall 20 of the housing 12. The pair of couplers 16 engages the vehicle 14 so the housing 12 is retained on the vehicle 14. The pair of couplers 16 may comprise an adhesive strip of any conventional design.

A processor 22 is coupled to the housing 12. The processor 22 is electrically coupled between an air conditioner 24 in the vehicle 14 and the vehicle electrical system 26. Moreover, the processor 22 actuates and de-actuates the air conditioner 24 in the vehicle 14. The processor 22 may be an electronic processor of any conventional design.

A level 28 is coupled to a top side 30 of the outer wall 20 of the housing 12. The level 28 extends between a first lateral side 32 and a second lateral side 34 of the outer wall 20 of the housing 12. Additionally, the level 28 may be a fluid bubble level of any conventional design. The housing 12 is coupled to the vehicle 14 so the level 28 indicates that the housing 12 is level with respect to a support surface 36. The support surface 36 may be ground.

An inclinometer 38 is coupled to the housing 12. The inclinometer 38 comprises a tube 40 extending between the first 32 and second 34 lateral sides of the outer wall 20 of the housing 12. The tube 40 may be comprised of an electrically conductive material. The tube 40 is positioned within an interior of the housing 12. Additionally, the tube 40 is positioned at an angle so a second end 44 of the tube 40 is positioned upwardly from a first end 42 of the tube 40. A bottom side 46 of the tube 40 may define a three percent grade with respect to level.

Each of a pair of contacts 48 is coupled to an associated one of the first 42 and second 44 ends of the tube 40. The pair of contacts 48 are each positioned within an interior of the tube 40. The tube 40 and each of the pair of contacts 48 are electrically coupled to the processor 22. A ball 50 is positioned within the tube 40. The ball 50 rolls freely within the tube 40. The ball 50 may be comprised of an electrically conductive material.

The ball 50 is positioned proximate the first end 42 of the tube 40 and engages an on one of the pair of contacts 52 when the vehicle 14 is level or if the vehicle 14 is travelling up an incline of less than a three percent grade. The ball 50 is electrically coupled between the tube 40 and the on contact 52. Additionally, the on contact 52 is placed in electrical communication with the processor 22 when the ball 50 engages the on contact 52. The processor 22 actuates the air conditioner 24 in the vehicle 14 when the ball 50 engages the on contact 52.

The ball 50 travels laterally toward the second end 44 of the tube 40 and engages an off one of the pair of contacts 54 when the vehicle 14 is traveling up an incline of greater than the three percent grade. The ball 50 is electrically coupled between the tube 40 and the off contact 54. The off contact 54 is placed in electrical communication with the processor 22 when the ball 50 engages the off contact 54. The processor 22 de-actuates the air conditioner 24 in the vehicle 14 when the ball 50 engages the off contact 54.

A timer 56 is coupled to the housing 12. The timer 56 is electrically coupled to the processor 22. The processor 22 alternatively actuates and de-actuates the air conditioner 24 in the vehicle 14 if the vehicle 14 is travelling up the incline for a duration of time that exceeds a trigger duration of time. The timer 56 may be an electronic timer of any conventional design.

In use, the processor 22 de-actuates the air conditioner 24 in the vehicle 14 when the vehicle 14 begins travelling up the incline of greater than the three percent grade. The trigger duration of time to keep the air conditioner 24 de-actuated is between two and three minutes. The processor 22 actuates the air conditioner 24 for a period of one minute if the vehicle 14 continues to travel up the incline after the trigger duration of time has passed. After the one minute duration of time has passed, the processor 22 de-actuates the air conditioner 24 for the trigger duration of time. The processor 22 continues to alternately actuate and de-actuate the air conditioner 24 until the vehicle 14 is no longer travelling up the incline.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An air conditioner control assembly for disabling the air conditioner in a vehicle while the vehicle is traveling up an incline, said assembly comprising:
a housing coupled to the vehicle;
a processor coupled to said housing, said processor being operationally coupled to the air conditioner in the vehicle such that said processor de-actuates the air conditioner;
a inclinometer coupled to said housing, said inclinometer being operationally coupled to said processor such that said processor de-actuates the air conditioner when said inclinometer detects the vehicle is traveling up the incline; and
a timer coupled to said housing; said timer being operationally coupled to said processor, said processor actuating the air conditioner after a trigger duration of time has passed while the vehicle is traveling up the incline.

2. The assembly according to claim 1, further comprising said processor being electrically coupled between the air conditioner in the vehicle and the vehicle electrical system.

3. The assembly according to claim 1, further comprising said inclinometer comprising a tube extending between a first lateral side and a second lateral side of an outer wall of said housing, said tube being positioned within an interior of said housing.

4. The assembly according to claim 3, further comprising said tube being positioned at an angle such that a second end of said tube is positioned upwardly from a first end of said tube.

5. The assembly according to claim 1, further comprising a pair of contacts each coupled to an associated one of a first end and a second end of a tube such that said pair of contacts are each positioned within an interior of said tube.

6. The assembly according to claim 1, further comprising a tube and each of a pair of contacts being electrically coupled to said processor.

7. The assembly according to claim 1, further comprising a ball positioned within a tube such that said ball rolls freely within said tube.

8. The assembly according to claim 1, further comprising a ball being positioned proximate a first end of a tube and engaging an on one of a pair of contacts when the vehicle is level such that said ball is electrically coupled between a tube and said on contact, said on contact being placed in electrical communication with said processor when said ball engages said on contact.

9. The assembly according to claim 8, further comprising said processor actuating the air conditioner in the vehicle when said ball engages said on contact.

10. The assembly according to claim 1, further comprising a ball travelling laterally toward a second end of a tube and engaging an off one of a pair of contacts when the vehicle is traveling up the incline such that said ball is electrically coupled between a tube and said off contact, said off contact being placed in electrical communication with said processor when said ball engages said off contact.

11. The assembly according to claim 10, further comprising said processor de-actuating the air conditioner in the vehicle when said ball engages said off contact.

12. The assembly according to claim 1, further comprising said timer being electrically coupled to said processor.

13. The assembly according to claim 1, further comprising said processor alternatively actuating and de-actuating the air conditioner in the vehicle if the vehicle is travelling up the incline for a duration of time that exceeds a trigger duration of time.

14. An air conditioner control assembly for disabling the air conditioner in a vehicle while the vehicle is traveling up an incline, said assembly comprising:
a housing coupled to the vehicle;
a processor coupled to said housing, said processor being electrically coupled between the air conditioner in the vehicle and the vehicle electrical system such that said processor actuates and de-actuates the air conditioner;
a inclinometer coupled to said housing, said inclinometer comprising a tube extending between a first lateral side and a second lateral side of an outer wall of said housing;
said tube being positioned within an interior of said housing, said tube being positioned at an angle such that a second end of said tube is positioned upwardly from a first end of said tube;
a pair of contacts each coupled to an associated one of said first and second ends of said tube such that said pair of contacts are each positioned within an interior of said tube;
said tube and each of said pair of contacts being electrically coupled to said processor;
a ball positioned within said tube such that said ball rolls freely within said tube;
said ball being positioned proximate said first end of said tube and engaging an on one of said pair of contacts when the vehicle is level such that said ball is electrically coupled between said tube and said on contact, said on contact being placed in electrical communication with said processor when said ball engages said on contact, said processor actuating the air conditioner in the vehicle when said ball engages said on contact;
said ball travelling laterally toward said second end of said tube and engaging an off one of said pair of contacts when the vehicle is traveling up the incline such that said ball is electrically coupled between said tube and said off contact, said off contact being placed in electrical communication with said processor when said ball engages said off contact, said processor de-actuating the air conditioner in the vehicle when said ball engages said off contact; and
a timer coupled to said housing; said timer being electrically coupled to said processor, said processor alternatively actuating and de-actuating the air conditioner in the vehicle if the vehicle is travelling up the incline for a duration of time that exceeds a trigger duration of time.
